(19) United States
(12) Patent Application Publication
(10) Pub. No.: US 2023/0087569 A1
(43) Pub. Date: Mar. 23, 2023

(54) AUTOMATIC TEST GENERATION FOR HIGHLY COMPLEX EXISTING SOFTWARE

(71) Applicant: Mobileye Vision Technologies Ltd., Jerusalem (IL)

(72) Inventors: Elya Gurvitz, Eli (IL); Amit Kimelman, Har Adar (IL); Simone Fabris, Tel Aviv (IL)

(21) Appl. No.: 17/612,670

(22) PCT Filed: Mar. 11, 2021
(86) PCT No.: PCT/IB2021/052058

§ 371 Date: Nov. 19, 2021

Related U.S. Application Data
(60) Provisional application No. 63/104,191, filed on Oct. 22, 2020.

(51) Int. Cl. G06F 11/36

(52) U.S. Cl. CPC G06F 11/3684; G06F 11/3676

(57) ABSTRACT

Techniques are disclosed for the generation of automatic software tests for complex software systems, such as operating systems (OS) and/or systems that may be implemented as part of an autonomous vehicle (AV) or advanced driving assistance system (ADAS). The technique generates tests using a tool, such as a stressor, which stresses a particular system under test in multiple ways. For every run of the stressor, the functions of the system that are invoked during the test are captured. A check is then performed to determine if this set of functions corresponds to one of the test scenarios for which testing is desired. If the set of functions that were invoked matches the set of functions that defines the test, then the configuration of the stressor is stored, and this stressor configuration is considered as the test for a particular scenario.

### CROSS-REFERENCE TO RELATED APPLICATIONS

This application claims priority to provisional application No. 63/104,191, filed on Oct. 22, 2020, the contents of which are incorporated herein by reference in its entirety.

### TECHNICAL FIELD

Aspects described herein generally relate to software testing systems and, more particularly, to techniques that automatically generate software tests for complex software.

### BACKGROUND

Functional safety standards such as IEC 61508 or ISO 26262 describe several methods to facilitate claiming that software (SW) is safe. In particular, IEC 61508 part 7 annex D suggests a “probabilistic approach to determine SW safety integrity for pre-developed SW.” For instance, the introduction of annex D provides “initial guidelines on the use of a probabilistic approach to determining software safety integrity for pre-developed software based on operational experience. This approach is considered particularly appropriate as part of the qualification of operating systems, library modules, compilers, and other system software. The annex provides an indication of what is possible, but the techniques should be used only by those who are competent in statistical analysis.” Current software testing in accordance with such guidelines, however, is inadequate and has various drawbacks, particularly with respect to the time and effort required to perform such testing.

### BRIEF DESCRIPTION OF THE DRAWINGS/FIGURES

The exemplary aspects of the present disclosure will be described with reference to the accompanying drawings. The drawing in which an element first appears is typically indicated by the leftmost digit(s) in the corresponding reference number.

The accompanying drawings, which are incorporated herein and form a part of the specification, illustrate the aspects of the present disclosure and, together with the description, and further serve to explain the principles of the aspects and to enable a person skilled in the pertinent art to make and use the aspects.

In the drawings, like reference characters generally refer to the same parts throughout the different views. The drawings are not necessarily to scale, emphasis instead generally being placed upon illustrating the principles of the disclosure. In the following description, various embodiments of the disclosure are described with reference to the following drawings, in which:

FIG. 1 illustrates an example test generation device, in accordance with various aspects of the present disclosure;

FIG. 2 illustrates an example entity-relationship diagram associate with generating a software test, in accordance with various aspects of the present disclosure;

FIG. 3 illustrates a first example of a software test generation process flow, in accordance with various aspects of the present disclosure;

FIG. 4 illustrates a second example of a software test generation process flow, in accordance with various aspects of the present disclosure;

FIG. 5 illustrates an example process flow for generating a software test using detected instances of potential interference between functions, in accordance with various aspects of the present disclosure;

FIG. 6 illustrates an example of potential global variable interference, in accordance with various aspects of the present disclosure;

FIG. 7 illustrates an example of potential static variable interference, in accordance with various aspects of the present disclosure.

### DETAILED DESCRIPTION

The following detailed description refers to the accompanying drawings that show, by way of illustration, exemplary details in which the aspects of the disclosure may be practiced. In the following description, numerous specific details are set forth in order to provide a thorough understanding of the aspects of the present disclosure. However, it will be apparent to those skilled in the art that the aspects, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring aspects of the disclosure.

Again, current software testing standards such as the IEC 61508 part 7 annex D as noted above, for example, have various drawbacks. For instance, the technique explained with reference to the IEC 61508 part 7 annex D allows a user to claim high integrity levels of existing SW by testing the SW over sufficiently long periods of time. However, this technique has drawbacks in that time alone is not enough. Instead, SW safety test requirements also require that the tests are effective when executed for these long durations, i.e. the tests can detect the failures whose absence must be demonstrated. The aspects described herein are directed to techniques for automatically generating software tests that address these existing issues.

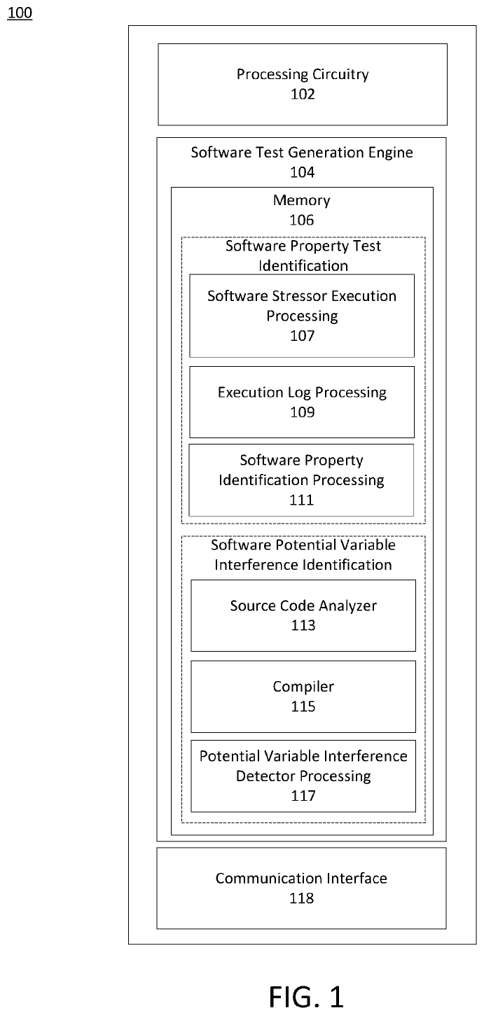

FIG. 1 illustrates an example test generation device, in accordance with various aspects of the present disclosure. The test generation device 100 may alternatively be referred to as a test platform, test suite, or testing tool. The test generation device 100 is configured to generate a software test for testing software associated with a safety-related system, as further discussed herein. In an aspect, the test generation device 100 may be implemented in different ways depending upon the particular application, type, and use with respect to the system in which it is installed or otherwise forms a part. For instance, the test generation device 100 may be identified with one or more portions of a computing platform such as a server computer, a cloud computing platform, a mobile device, a laptop computer, a customized programmable device, etc. Regardless of the particular implementation, to perform the various functionality as described herein, the test generation device 100 may include processing circuitry 102, a memory 106, and a communication interface 118. The components shown in FIG. 1 are provided for ease of explanation, and aspects include the test generation device 100 implementing additional, less, or alternative components as those shown in FIG. 1.

In various aspects, the processing circuitry 102 may be configured as any suitable number and/or type of computer processors, which may function to control the test generation device 100 or other components of the system in which it is implemented. Processing circuitry 102 may be identified with one or more processors (or suitable portions thereof) implemented by the test generation device 100. For example, the processing circuitry 102 may, for example, be identified with one or more processors such as a host processor, a digital signal processor, one or more microprocessors, graphics processors, microcontrollers, an application-specific integrated circuit (ASIC), part (or the entirety of) a field-programmable gate array (FPGA), etc.

In any event, aspects include the processing circuitry 102 being configured to carry out instructions to perform arithmetical, logical, and/or input/output (I/O) operations, and/or to control the operation of one or more components of the test generation device 100 to perform various functions associated with the aspects as described herein to generate a software test for a specific system under test, which may include a safety-related system. For example, the processing circuitry 102 may include one or more microprocessor cores, memory registers, buffers, clocks, etc., and may generate electronic control signals associated with electronic components to control and/or modify the operation of one or more components of the test generation device 100 and/or components of the system in which it is implemented as discussed herein. Moreover, aspects include the processing circuitry 102 communicating with and/or controlling functions associated with the memory 106 and/or the communication interface 118.

Again, in an aspect the test generation device 100 is configured to generate a software test for a specific type of software implemented by a system under test. This may be, for instance, to ensure functional safety standards are met for a specific type of software and applications of that software. For instance, the test generation device 100 may interface with a system under test and/or receive source code identified with a particular system under test. This system under test may include any suitable type of software that implements safety-related (SR) and non-safety-related (NSR) functions as part of its operation, as further discussed below, and thus requires software testing to meet applicable regulatory requirements for its deployment and/or use within an applicable system. As some examples, the system under test may be software that is implemented as part of an advanced driving assistance system (ADAS), a driving assistance, and/or an automated driving system (AV system) identified with a vehicle. Such a vehicle may implement various hardware components that rely upon the operation of this software to perform maneuvers and execute fully or partially autonomous functions such as navigation, for instance, in a particular environment.

The aspects described herein may implement the test generation device 100 to generate software tests to be used for testing the software of such a system for regulatory or other purposes, but are not limited to such examples. Instead, the aspects described herein may be implemented to test any suitable type of software used in accordance with any suitable type of device and/or components. However, the aspects described herein may be particularly useful to generate tests for more “complex” software, which may otherwise be difficult to test due to the high number of function calls, the presence of both SR and NSR functions, and/or a high number of interactions among variables and other software components, which may be present in safety-related systems subjected to regulatory testing, operating systems, customized operating systems used for systems subjected to regulatory testing requirements, etc. Software including both NSR and SR functions may alternatively be referred to herein as mixed-criticality software, and may be a specific example of the complex software systems to which the aspects herein are directed to generating tests. In any event, complex software systems may have various failure modes that are difficult to detect or otherwise collect as part of a robust software solution, and the aspects described herein advantageously provide a means by which such complex systems may be efficiently and thoroughly tested.

To do so, the test generation device 100 may include a software test generation engine 104 that may operate in accordance with the execution of instructions stored in the memory 106, as further discussed herein. The software test generation engine 104 may represent an interaction between hardware and software components of the test generation device 100 to facilitate the functionality discussed herein with respect to the generation of a software test associated with a system under test. This functionality, which are further discussed below, may include for example the determination of software properties to be tested, determining specific stressor configurations to capture the desired software properties to be tested, identifying potential functions for causing interference points in the software to be tested, etc.

To do so, aspects include the memory 106 storing data and/or instructions such that, when the instructions are executed by the processing circuitry 102, the test generation device 100 performs the various functions as described herein to generate a software test. The memory 106 may be implemented as any well-known volatile and/or non-volatile memory, including, for example, read-only memory (ROM), random access memory (RAM), flash memory, a magnetic storage media, an optical disc, erasable programmable read only memory (EPROM), programmable read only memory (PROM), etc. The memory 106 may be non-removable, removable, or a combination of both. For example, the memory 106 may be implemented as a non-transitory computer readable medium storing one or more executable instructions such as, for example, logic, algorithms, code, etc.

As further discussed below, the instructions, logic, code, etc., stored in the memory 106 are represented by the various modules as shown in FIG. 1, which may enable the aspects disclosed herein to be functionally realized. Alternatively, if the aspects described herein are implemented via hardware, the modules shown in FIG. 1 associated with the memory 106 may include instructions and/or code to facilitate control and/or monitor the operation of such hardware components. In other words, the modules shown in FIG. 1 are provided for ease of explanation regarding the functional association between hardware and software components. Thus, aspects include the processing circuitry 102 executing the instructions stored in these respective modules in conjunction with one or more hardware components to perform the various functions associated with the aspects as further discussed herein. The functionality of each of the modules stored in the memory 106 is discussed in further detail below with respect to the various Figures.

In an aspect, the test generation device 100 may implement a communication interface 118. The communication interface 118 may enable communications between the test generation device 100 and a system under test (e.g. software that is executed in accordance with a physical system) in accordance with any suitable number and/or type of communication protocol(s). The communication interface 118 may function to support the functionality with respect to the various modules as shown in FIG. 1 and further discussed herein, for example, by enabling the exchange of data with the software executed via a particular system that is to be tested. This may include, for example, facilitating an exchange of data via one or more application programming interfaces (APIs) to enable the test generation device 100 to interact with the system under test by receiving source code and/or receiving feedback from the systems under test in response to the execution of various stressors.

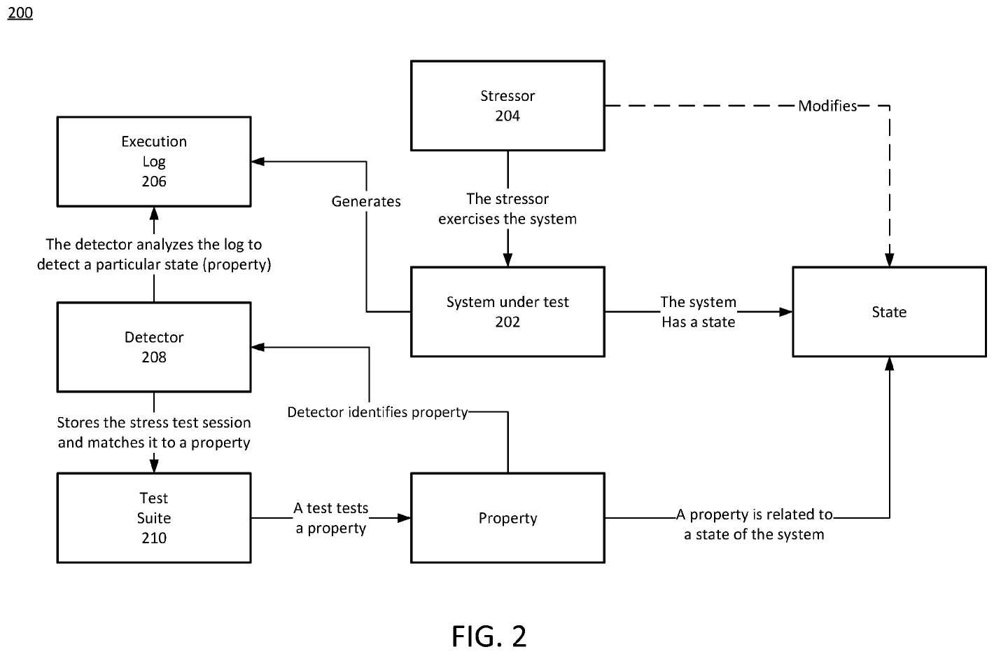

FIG. 2 illustrates an example entity-relationship diagram associated with generating a software test, in accordance with various aspects of the present disclosure. The example entity-relationship diagram shown in FIG. 2 also illustrates an overall process flow and indicates a relationship between various entities that results in the generation of a software test as shown in FIG. 2. The example entity-relationship 200 includes various blocks, which may be identified with the different entities of the system under test 202 and/or the components of the test generation device 100 such that a robust software test may be generated to test for various states and/or properties of the system under test 202.

For instance, the test suite 210 and detector 208 may be identified with the test generation device 100 and the execution of the software property test identification portion of the software test generation engine 104, as discussed above. As further discussed below, the test generation device 100 may function to generate a software test by first identifying various properties of the system under test 202 that are to be tested. The manner in which such properties may be determined is further discussed below. For each one of the identified properties to be tested, the test generation device 100 may determine a test for the system under test 202 in accordance with that specific property and accompanying state of the system under test using a specific software stressor configuration. After each particular stressor configuration is executed, the system under test 202 may then generate a resulting execution log 206, which is received by the test generator device 100 as a form of feedback. The communication between the test generation device 100 and the system under test 202 may be performed in this manner via the communication interface 118, and the results of the execution log 206 may be stored in the memory 206, for instance. From an analysis of the results stored in the execution log 206, the test generation device 100 may thus determine which software stressor configurations resulted in the detection of the respective properties that are sought to be tested, thereby identifying a successful software test for that specific property. Using this information, the test generation device 100 may then generate a software test for the system under test 202 that identifies each property to be tested and the corresponding stressor configurations used to detect those properties. In this way, the test generation device 100 may identify a comprehensive test that, when used to test the system under test 202 as part of a software certification or other testing mode, for example, ensures that each desired property of the system under test 202 is sufficiently tested.

For example, a state of the system under test 202 may be defined based upon the contents of memory used to execute the software associated with the system under test 202. That is, the contents of the memory used by the system under test 202 may change based upon the particular functions called by the software under test 202 and the specific scenario or operative state of the system in which the system under test 202 is implemented. As an illustrative example, the system under test 202 may be implemented as any suitable type of operating system (e.g. Linux) or other suitable complex software system (e.g. one having several function calls, a large function tree, etc.), and which may be customized to enable control and/or interaction of various control systems, components, sub-systems, etc. of an AV or ADAS system that may be present in a vehicle. In an aspect, the system under test 202 may include or provide software control and support over any (or all) portions of the AV or ADAS system in the vehicle such as navigation functions, infotainment functions, autonomous functions, sensors, computer vision processing, etc.

The system under test 202 may thus facilitate a graphical and/or other suitable type of user interface, which may be used for the operation of the various control systems, components, sub-systems, etc. within the vehicle such as infotainment controls, environmental controls, navigational controls such as autonomous driving controls, for instance, etc. As a user interacts with these different controls, the system under test 202 may call (or use) different functions that, in turn, result in a desired action, output, control, etc. being executed. Thus, a property of the system under test 202 to be tested may include, for example, the existence of specific functions that are used or called by the system under test 202 at a particular time, which is related to the state of the system under test as the use of these specific functions correspond to how the state of the system under test (i.e. the contents of the memory used by the system under test) is altered. Therefore, the execution log 208 may represent a result of executing a sequence of functions in accordance with specific stressor configurations, the functions being called to modify the contents of memory of the system under test 202. The state of the system under test 202 is thus defined in accordance with the contents of memory at a particular time, which is modified in accordance with specific function calls associated with the specific properties of the system under test 202 for which the test generation device 100 seeks to identify a test.

Therefore, aspects include the test generation device 100 initially identifying the properties of the software under test 202 for which a test is to be determined. The identification of the set of properties may be performed, for instance, via the processing circuitry 102 executing instructions stored in the software property identification processing module 111, which may store instructions to facilitate the identification of such properties for which a test is sought in any suitable manner. This may include, for example, analyzing the source code used by the system under test 202 using a script to identify functions that are called by the system under test 202 in different scenarios (e.g. states of the system under test 202), which may be stored or otherwise accessed via any suitable database structure (e.g. a relational database structure). The database or other suitable storage, memory, table, etc. that is used for this purpose is not shown in the Figures for purposes of brevity, but may include any suitable type of storage device used to store the function calls used by the system under test 202 and the relationship of those function calls to other function calls. The specific function calls to use as a property of the system under test 202 for which a test is sought may be acquired or queried from such a storage device in any suitable manner, including known techniques, the use of scripts, etc.

Thus, the existence of specific functions associated with a property of the system under test 202 for which a test is sought may be obtained in any suitable manner based upon knowledge of the system under test. Consider, as an example, a class of failures—interference between functions. These failures can occur in mixed-criticality software (e.g. software that consists of both safety-related and non-safety-related parts, for example the Linux OS) in which a NSR function passes information to an SR function, and this information (a function argument) is faulty. The SR function uses the faulty value, and this causes a fault down the line (this is known as a “cascading failure”). The conventional mitigation for such cascading failures, according to IEC 61508, is to perform a suitable test for a sufficiently long period of time. However, the standard does not provide guidance regarding how a suitable test can be generated. Sometimes, the relevant NSR and SR functions are called at a very deep level in the call stack, and their invocation depends on multiple branches that must be traversed in a specific order. Developing a suitable test based on understanding of the code, or by analysis, is very difficult and sometimes impossible. The aspects described herein address these issues by facilitating the automatic generation of such tests to address these issues.

Thus, an SR system may use both NSR functions as part of the same state, and thus a test may be sought for specific states of the system under test 202 in which both SR functions are either called or access variables that may be influenced by other SR function calls and/or NSR function calls. Thus, the properties of the system under test 202 for which a test is sought may include, for example, various combinations of such SR and NSR functions or any suitable combination of function calls for which a test is to be generated to capture potential issues or failures as a result of the system under test calling such functions during its ordinary or expected operation. Moreover, although identifying different properties for which to seek a test as a result of the mere existence of specific functions may be performed as stated above (e.g. using a script), it may be particularly advantageous to generate specific tests for those function calls that, when existing together for a particular state of the system under test 202, may potentially create interference points with respect to the static and/or global variables used by the NSR and/or SR functions, which is further discussed below.

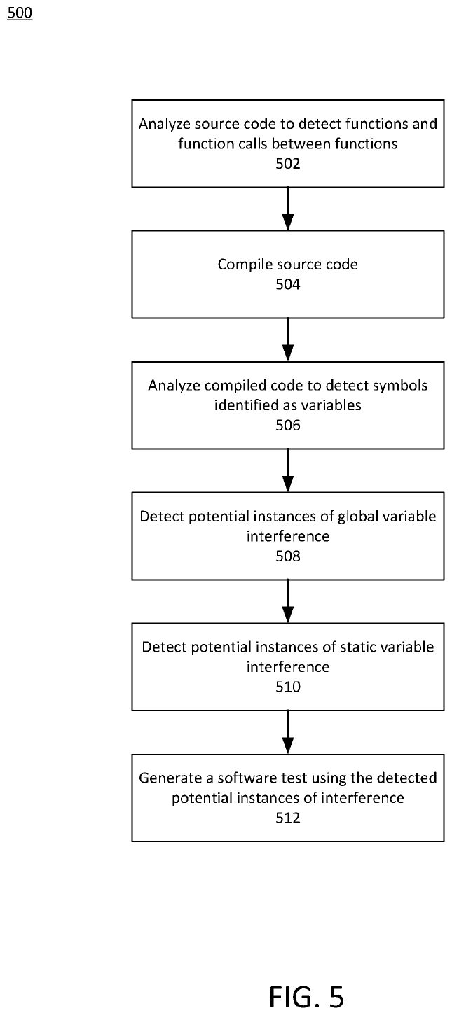

Again, the identification of the properties of the software under test 202 for which a test is to be generated may include identifying interference between function calls, and may be particularly useful for safety-related systems. The identification of interference points between function calls is further discussed herein with reference to FIGS. 5-7, and the existence of such interference points is one example of a property of the system under test 202 for which a test is sought to be identified as further discussed herein. However, the mere existence of two or more specific function calls may also constitute a property of the system under test 202 for which a test is to be determined, as well as any other action, memory contents, executed tasks, etc., that may be performed by the system under test 202 in accordance with one or more specific states of the system under test 202 as discussed herein.

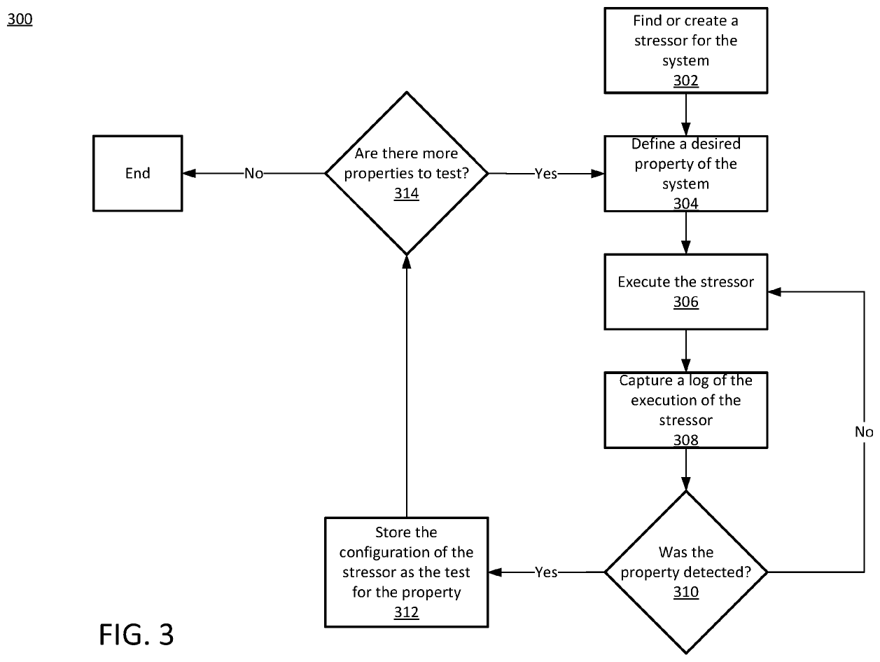

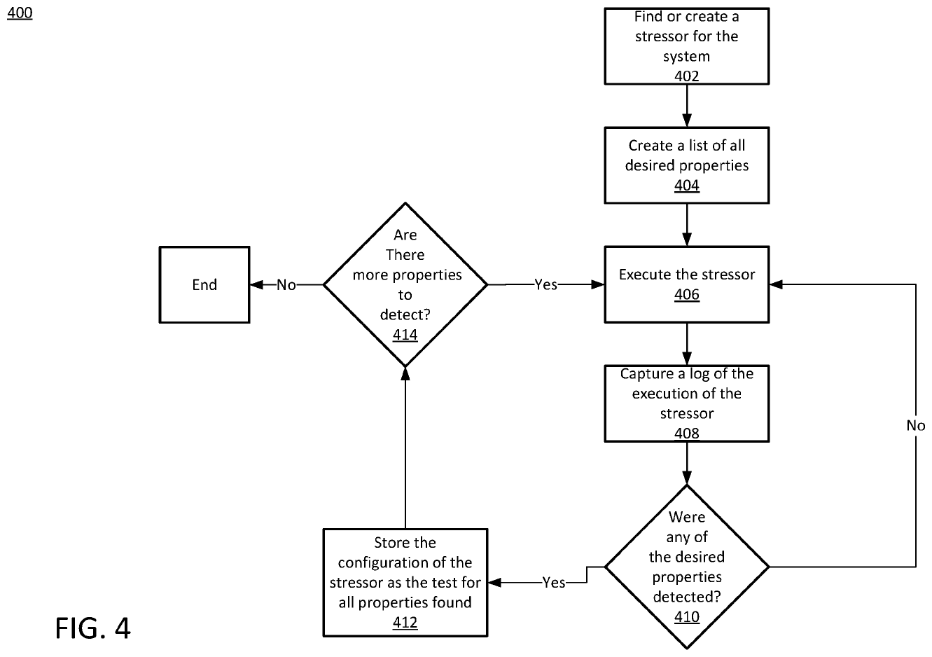

In any event, aspects include the test generation device 100 initially identifying the properties of the system under test 202 to be tested, and then identifying a specific test that results in the identification of that property such that it is ensured that the test, when later executed, results in the sufficient identification of those specific properties. The process by which a software test is determined, which includes each test for each specific property as desired, may be performed for example via the processing circuitry 102 executing instructions stored in the modules identified with the software test generation engine 104, as shown and discussed herein with reference to FIG. 1. This may include, for example, the generation of a software test as is further discussed below with reference to FIGS. 3-4, as well as the identification of specific properties (e.g. function call and/or use combinations) to use in the generation of the overall software test, as further discussed with reference to FIGS. 5-7.

FIG. 3 illustrates a first example of a software test generation process flow, in accordance with various aspects of the present disclosure. The process flow 300 as shown in FIG. 3 may be performed, for example, as the result of the processing circuitry 102 executing instructions stored in the modules identified with the software test generation engine 104. The process flow 300 may be performed in accordance with a set of predefined (e.g. already identified) properties of the system under test 202 to be tested, which may be stored or otherwise accessed via the test generation device 100 as part of a finite list of software properties for which software tests are sought. In an aspect, the process flow 300 may begin with the processing circuitry 102 executing the instructions stored in the software stressor execution processing module 107 to select a specific stressor based upon the properties for which tests are sought (e.g. specific function calls) (block 302).

As discussed herein, a software stressor may include any suitable software component that calls an external application programming interface (API) for the system under test 202, with the purpose of making any suitable number of function calls with a wide range of diversity. As an example, the stressor used by the test generation device 100 may include any suitable type of stressor, including known types, which may be selected or generated based upon the particular application and type of software associated with the system under test 202. For example, if the system under test 202 is implemented as a Linux-based OS, then the stressor used by the test generation device 100 may include stressors such as Linux stress-ng, Linux syzkaller, etc. Stress-ng, as an example, allows for the use of hundreds of options to test every aspect of Linux by invoking system calls. The specific number and type of function calls associated with a stressor may thus be identified with the parameters of a stressor configuration, with each stressor configuration defining a respective set of stress mechanisms (e.g. a different number and/or type of function calls). As an illustrative example, the tress-ng stressor may have parameters as part of various configurations for quickly consuming memory, generating a large interrupt load, causing page faults, etc. Thus, finding or creating (block 302) a stressor for the system under test 202 may include identifying, generating, or otherwise accessing (block 302) a stressor that may have different configurations of stress mechanisms that encompass the functions associated with the properties of the software for which a test is sought. In an aspect, the process flow 300 may advantageously execute stressors in accordance with a system under test 202 that is instrumented for code coverage, which allows for the identification of software tests that reach specific lines within functions. In other words, the use of code coverage via the system under test 202 ensures that a stressor causes particular lines of code (and not only functions) to be accessed.

The process flow 300 may include the processing circuitry 102 executing the instructions stored in the software property identification processing module 111 to define (block 304) a desired property of the system under test 202 for which a test is sought. In an aspect, this may include the selection of a specific property from the set of predefined properties of the under test 202 to be tested. Again, the defined property of the system under test 202 may include the existence of specific function calls or those function calls that are suspected as having one or more potential interference points between one another.

Thus, the process flow 300 includes the processing circuitry 102 executing (block 306) the software stressor in accordance with an initial stressor configuration that defines the tests to be executed via a set of stress mechanisms. In an aspect, the initial stressor configuration may be randomly selected from all available stressor configurations or selected in accordance with a predefined stored stressor configuration list. In any event, upon execution of the stressor, the system under test 202 responds by generating (block 308) an execution log of results as feedback, which is then received by the test generation device 100 and stored in the memory 106 or in any other suitable storage location. Aspects include the processing circuitry 102 executing the instructions stored in the execution log processing module 109 to facilitate the test generation device 100 capturing the generated execution log of the results. Thus, aspects include the test generation device 100 determining the function invocations of the system under test 202 (e.g. all function invocations) for a specific property based upon an analysis of the execution log. This may be accomplished, for instance, using any suitable techniques, including known techniques such as Linux ftrace, kprobes, or a profiler, for example.

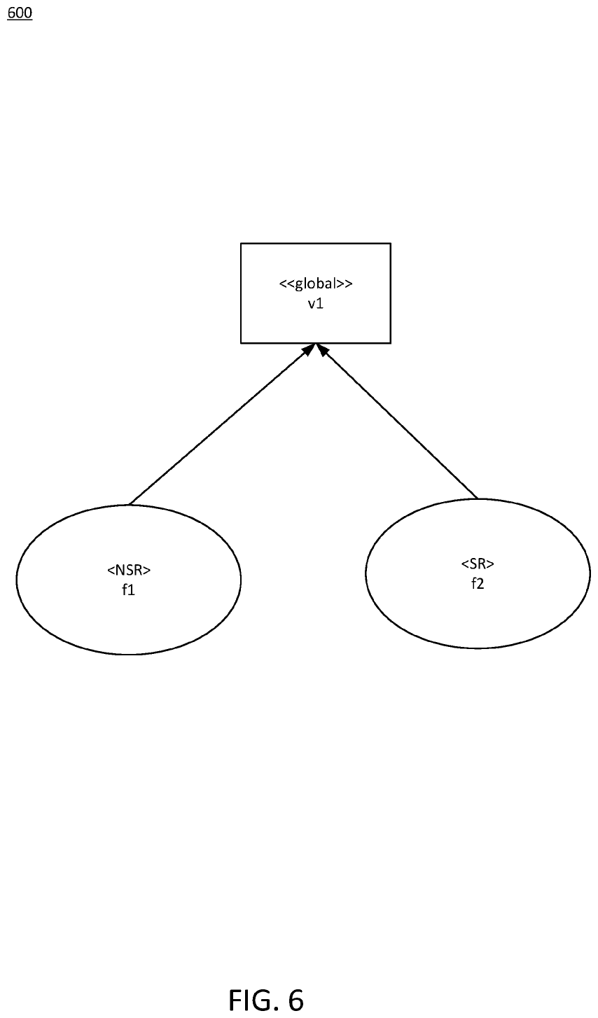

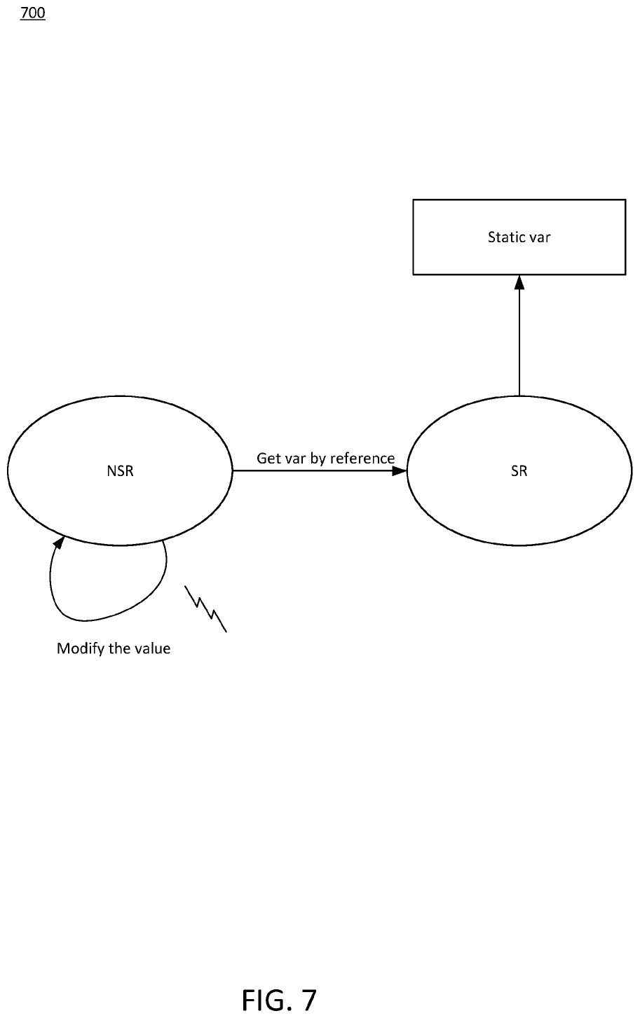

Aspects further include the processing circuitry 102 executing the instructions stored in the software property identification processing module 111 to analyze the captured execution log of results to determine whether a property of the system under test 202 was detected for the specific stressor configuration and property. This may include, for example, determining whether the stressor configuration allows interference between variables to occur (e.g. static or global variable interference) by means of executing called functions, as discussed in further detail below with reference to FIGS. 6 and 7. If the property of the software to be tested is identified in the execution log, aspects include the test generation device 100 storing the corresponding stressor configuration (e.g. the initial stressor configuration) associated with the detection of that particular property of the software. In other words, if the functions that were invoked via the stressor configuration parameters correspond to a set of functions for a defined property, then the particular configuration (e.g. parameters) of the stressor are identified and stored as the test to be used for that specific property. Thus, the specific stressor configuration for the executed stressor (block 306) is linked to or otherwise acknowledged as successfully testing for the specific property that was selected (block 304), and may be used for this purpose as part of a software test for testing the system under test 202 which may be associated with a safety-related system, for example.

However, in the event that the property of the software to be tested is not identified in the execution log, aspects include the test generation device 100 modifying or otherwise changing the stressor configuration to define the tests (e.g. different types and/or numbers of function calls) to be performed via a modified set of stress mechanisms that differ from the initial or previous set of stress mechanisms. This may include, for instance, randomly selecting or selecting from a predefined stressor configuration list a new stressor configuration having an accompanying set of stress mechanisms that are different than the initial set (or previously used sets) of stress mechanisms. Aspects of the process flow 300 include repeatedly executing software stressors in accordance with different stressor configurations (e.g. different respective sets of stress mechanisms) and capturing the execution log of the results of each software stressor execution in accordance with each different configuration until the property of the software to be tested is detected (block 310—yes). Again, once detected, the stressor configuration for that specific software property is stored, and this process is repeated, selecting or otherwise defining (block 304) the next property in the predefined list as shown in FIG. 3, until a test is identified for each property of the system under test 202.

In this way, upon completion of the process flow 300, a matching stressor configuration is identified that will result in a successful test of each property of the system under test 202 that is to be tested. This overall set of stressor configurations may thus form part of a comprehensive test of the system under test 202. In other words, the process flow 300 facilities the generation of a software test for the system under test 202 by capturing, for every run of the stressor with various configurations, the functions of the system under test 202 that are used in accordance with each property of the system to be tested. As an example, if the property defines a specific set of functions, then if the set of functions that were invoked as indicated in the execution log matches that set of functions, then the configuration of the stressor is stored and this stressor configuration is considered as the test for that particular property (i.e. to test for the existence of and/or interference created by the use of both functions in this example).

FIG. 4 illustrates a second example of a software test generation process flow, in accordance with various aspects of the present disclosure. The process flow 400 as shown in FIG. 4 represents an alternative to the test generation process flow 300 discussed above with reference to FIG. 3. The process flow 400 operates in a similar manner as the process flow 300, and thus only differences between these two process flows are discussed in further detail herein for purposes of brevity. In contrast to the process flow 300, the process flow 400 determines in advance (block 404) the desired properties of the system under test 202 that are to be tested. Thus, instead of iteratively analyzing the results of the execution log after each stressor execution for each property to be tested, as was the case for the process flow 300, the process flow 400 executes (block 406) a stressor having a configuration that includes several properties (e.g. function calls) associated with one or more of the properties in a predetermined list of properties already identified, as discussed above. The captured execution log (block 408) in this example includes a log of the results of executing the stressor in accordance with an initial set of stress mechanisms to cover functions for one or more of the properties in the overall predetermined list of properties to be tested. The process flow 400 includes an analysis (block 410) of the execution log to check, for a specific stressor configuration, if any properties were detected and, if so, to store the configuration of the stressor and then make the invocation of the stressor with this particular configuration the test for any of the detected properties by storing the corresponding stressor configuration parameters. As mentioned above for the process flow 300, the process flow 400 includes modifying the stressor configuration (e.g. randomly, from a list, etc.) and repeatedly executing (block 406) the stressor with a different configuration until all properties of the system under test 202 are detected (block 414). Upon each of the properties being detected, the overall set of stressor configurations thus forms part of a comprehensive test of the system under test 202. In other words, the process flow 400 as shown in FIG. 4 uses the stressor in the same manner as the process flow 300 as shown in FIG. 3, with each run of the stressor using a single configuration of parameters, which does not necessarily include all functions related to all properties in the predetermined list of properties to be tested. However, the process flow 400 differs from the process flow 300 in that the process flow 300 runs different stressors for each single property, whereas the process flow 400 runs a stressor configuration and then checks for all properties if (e.g. only if) that configuration was suitable. This process is then repeated for the next stressor configuration until all properties to be tested are identified.

A detailed example of tests that may be generated for specific properties of the system under test 202 are provided with reference to FIGS. 4 and 5. In this example, the system under test 202 may be implemented as a Linux-based operating system identified with a safety-related system such as an AV or ADAS system in a vehicle, for example. In this example, the process flow 300 or 400 may be implemented to generate a software test to demonstrate freedom from interference between SR functions and NSR functions of the Linux-based software. For example, in the Linux OS for EyeQ5 (which is referred to as SCL—Safety Critical Linux), memory management is safety-related, while networking (TCP/IP) is not safety-related. Therefore, it may be the case that a bug in the TCP/IP stack will cause a corruption of memory, i.e. the bug may cause an erroneous write into a random memory location, and thereby corrupt the memory of a SR application.

Another scenario is that the supposedly buggy TCP/IP code will corrupt the state of the kernel. This change of state may cause a safety-related feature like memory management to fail. The state of the kernel in this context includes the total of data that the kernel stores in memory. These blocks of data, which are used in accordance with specifically-called functions, may be referred to herein as global and static variables. The detection of global and static variable interference between different functions, i.e. whether such interference exists as a result of specific functions being called, may represent one of the properties of the system under test 202 for which a test is to be generated in the process flows 300, 400 as noted above. Additional details regarding the manner in which potential interference between functions may be identified, and examples of such interference between static and global variables, is further discussed below with respect to FIGS. 5-7.

FIG. 5 illustrates an example process flow for generating a software test using detected instances of potential interference between functions, in accordance with various aspects of the present disclosure. For example, the process flow 500 may identify candidates of functions that may have potential global variable interference and/or potential static variable interference between one another in the blocks 502, 504, 506, 508, and 510. Once the instances of potential variable interference are identified, the process flow 500 also includes a block 512 for the generation of a software test using these identified function candidates of potential variable interference. In other words, the candidates for variable interference identified by the first blocks 502, 504, 506, 508, and 510 of the process flow 500 yield candidates to be used as the property of the software to be tested for the flows 300, 400.

The execution log analysis in accordance with a test (e.g. stressor execution) of the functions identified in this manner allow for the successful identification of whether global variable interference exists between the functions as a result of a variable being used by both a NSR function and a SR function and, alternatively or additionally, whether static variable interference exists between the functions as a result of a variable that is used by a SR function being called by a non-safety-related NSR function. That is, the execution log itself may not indicate that such interference exists, but may ensure that such interference, if present, will be detected upon the execution of a particular stressor configuration for the functions identified as candidates to potentially cause such interference.

To do so, the process flow 500 as shown in FIG. 5 may be executed by the software test generation device 100 as part of the software test generation engine 104. In this example, the processing circuitry 102 may execute, for instance, the instructions stored in the source code analyzer module 113, the compiler module 115, and the variable potential interference detector processing module 117, which form part of the software potential variable interference identification portion of the software test generation engine 104.

In an aspect, the process flow 500 starts with an analysis (block 502) of the source code associated with the system under test 202 to identify functions used by the system under test 202 and the function calls between these functions (e.g. function f1( ) calls function f2( )). This may be implemented, for instance, via the processing circuitry 102 executing the instructions stored in the source code analyzer module 113, as shown in FIG. 1. This analysis may be performed in accordance with any suitable techniques and/or tools to collect this information, including known techniques to do so. As an example, a flow graph generator (e.g. cflow) may be implemented to detect the functions used by the system under test 202 based upon an analysis of the source code. Alternatively, other tools such as a compiler (e.g. LLVM, gcc) may be used for this purpose.

The process flow 500 may include compiling (block 504) the source code associated with the system under test 202 to generate compiled code. In aspects in which the function and function call and/or use information is obtained using a compiler, this may alternatively be performed as part of this compiling process. The compilation of the source code may be performed using any suitable type of compiler to do so. This may be implemented, for instance, via the processing circuitry 102 executing the instructions stored in the compiler module 113, as shown in FIG. 1. As a result of the compilation of the source code, compiled code is generated including object files and executable files, for example, used by the system under test 202.

The process flow 500 further includes analyzing (block 506) the compiled code (e.g. the object files and/or executables) to detect symbols that can be identified as variables according to which section of the object files and/or the executable files the symbols are located. These symbols may include, for instance, named entities in software such as functions and variables. This may be implemented, for instance, via the processing circuitry 102 executing the instructions stored in the potential variable interference detector processing module 117, as shown in FIG. 1. In an aspect, the variables may thus be detected (block 506) by identifying, from the compiled source code, symbols located in a data section or a block starting symbol (bss) section of the object files and/or executable files.

The process flow 500 further includes detecting (block 508) potential instances of global variable interference as a result of a detected variable being used by both a non-safety-related (NSR) function and a safety-related (SR) function. An example of such a scenario is further illustrated in FIG. 6. In other words, the process flow 500 may identify candidates for potential instances of global variable interference when the same variable is used by both a NSR and an SR function used by the system under test 202.

Interference can also occur through static variables, which are limited to file or function scope. Thus, aspects include the process flow 500 further detecting (block 510) potential instances of static variable interference as a result of a detected variable being used by an SR function, and this function is called by an NSR function. An example of such a scenario is further illustrated in FIG. 7. As shown in FIG. 7, an interference point may exist due to the NSR function modifying the value of a static variable that is used by the SR function. In other words, the mechanism of interference in static variables occurs when an NSR function calls an SR function that handles a static variable, as shown in the diagram shown in FIG. 7.

As noted above, the process flow 500 also includes, once the potential instances of global and static variable interference are identified, using the associated NSR and SR functions as the basis of properties for which stressor configurations are executed to identify tests to detect interference points between the SR and NSR functions, should these exist. In this way, when a test is actually performed using the stressor configurations identified in accordance with the process flows 300, 400, as the total “state” of the OS is very complex, the mitigation to these possible interference points is to show that the system has been stressed long enough to give this interference a chance to occur. If interference does not occur between such candidate functions, then a determination may be made with high enough confidence that this interference does not occur.

To provide an illustrative example of the identification of an interference point using the tests generated in accordance with the process flows 300, 400, as discussed herein, a stressor is assumed to be executed in many of its possible configurations for a property to be tested, which in this example includes identifying a test to ensure the detection of global or static variable interference between two candidate functions that may potentially result in such interference. Thus, the stressor may be executed in accordance with various configurations for a specific set of functions (e.g. those identified via the process flow 500 discussed above). After each run, a check is made in the execution log for which functions were invoked by the system under test 202. If it is found that an NSR function that is being searched for called an SR function that is being searched for, then this run of stress-ng (e.g. the specific stressor configuration) is marked or otherwise identified as the test for this potential interference point.

Table 1 below is part of a search for interference via static variables, which may be performed by the test generation device 100 or another suitable device with respect to a search of the execution log discussed herein. As shown in the Table 1 below, lines 75 and 76 illustrate that pairs of functions were found during a run of stress-ng, and therefore a valid test scenario for the static variable ‘deferred_probe_work’ is created. However, no invocation of functions for the variable ‘gdp_mutex’ was identified, so there is no test is identified using the same configuration for stress-ng in this scenario.

TABLE 1

| | Variable | To function | From Function | Status |
|---|---|---|---|---|
| 71 | gdp_mutex | | | |
| 72 | | device_add | cleanup_glue_dir | un-reachable |
| 73 | | device_move | cleanup_glue_dir | un-reachable |
| 74 | deferred_probe_work | | | |
| 75 | | device_shutdown | wait_for_device_probe | Found |
| 76 | | device_block_probing | wait_for_device_probe | Found |
| 77 | | add_device | wait_for_device_probe | un-reachable |
| 78 | | prepare_namespace | wait_for_device_probe | un-reachable |

In closing, it is noted that the aspects described herein are provided with respect to a safety-related system, with examples of such safety-related system being implemented as part of an AV or ADAS system in a vehicle. However, this is by way of example and not limitation, and the aspects described herein may be implemented in other software applications in which it is possible to define tests as having some desired property, there exists a stressor for the system, and/or the desired property can be detected automatically.

### EXAMPLES

The following examples pertain to further aspects.

Example 1 is a software test generation device, comprising: one or more processors; and a memory configured to store instructions that, when executed by the one or more processors, cause the one or more processors to generate a software test for software associated with a safety-related system by: determining a property of the software to be tested; executing a software stressor in accordance with a stressor configuration that defines software tests to be performed via an initial set of stress mechanisms; capturing a data log of results of executing the software stressor in accordance with each one of the initial set of stress mechanisms; and when the data log indicates that the property of the software to be tested was not detected: modifying the stressor configuration to define software tests to be performed via a modified set of stress mechanisms that differ from the initial set of stress mechanisms; and repeatedly executing software stressors in accordance with stressor configurations having different respective sets of stress mechanisms and capturing the data log of results of each software stressor execution until the property of the software to be tested is detected.

In Example 2, the subject matter of Example 1, wherein the memory is configured to store instructions that, when executed by the one or more processors, further cause the one or more processors to generate the software test by: upon detecting the property of the software to be tested, storing a corresponding stressor configuration associated with the detection of the property of the software to be detected as part of the software test for testing the software associated with the safety-related system.

In Example 3, the subject matter of any combination of Examples 1-2, wherein the memory is configured to store instructions that, when executed by the one or more processors, further cause the one or more processors to generate the software test by: repeating, for each one of a set of properties of the software to be tested (i) determining a property from among the set of properties of the software to be tested, (ii) executing a software stressor in accordance with respective stressor configurations until each one of a set of properties of the software to be tested is detected, and (iii) storing each corresponding stressor configuration associated with the detection of each respective property of the software to be detected as part of the software test for testing the software associated with the safety-related system.

In Example 4, the subject matter of any combination of Examples 1-3, wherein modifying the initial stressor configuration includes randomly selecting a stressor configuration having an accompanying set of stress mechanisms that are different than the initial set of stress mechanisms.

In Example 5, the subject matter of any combination of Examples 1-4, wherein determining the property of the software to be tested includes identifying functions of the software associated with the safety-related system to be tested in accordance with a specific state of the safety-related system.

In Example 6, the subject matter of any combination of Examples 1-5, wherein the memory is configured to store instructions that, when executed by the one or more processors, further cause the one or more processors to determine, as the property of the software to be tested whether global variable interference exists between the functions as a result of a variable being used by both a non-safety-related (NSR) function and a safety-related (SR) function.

In Example 7, the subject matter of any combination of Examples 1-6, wherein the memory is configured to store instructions that, when executed by the one or more processors, further cause the one or more processors to determine, as the property of the software to be tested whether static variable interference exists between the functions as a result of a variable that is used by a safety-related (SR) function being called by a non-safety-related (NSR) function.

In Example 8, the subject matter of any combination of Examples 1-7, wherein the stressor is associated with a Linux operating system stressor including at least one of Linux stress-ng and Linux syzkaller.

Example 9 is a software test generation device, comprising: one or more processors; and a memory configured to store instructions that, when executed by the one or more processors, cause the one or more processors to generate a software test for software associated with a safety-related system by: determining a set of properties of the software to be tested; executing a software stressor in accordance with a stressor configuration that defines software tests to be performed via an initial set of stress mechanisms; capturing a data log of results of executing the software stressor in accordance with each one of the initial set of stress mechanisms; and when the data log indicates that none of the set of properties of the software to be tested was detected: modifying the stressor configuration to define software tests to be performed via a modified set of stress mechanisms that differ from the initial set of stress mechanisms; and repeatedly executing software stressors in accordance with stressor configurations having different respective sets of stress mechanisms and capturing the data log of results of each software stressor execution until each one of the set of properties to be tested is detected.

In Example 10, the subject matter of Example 9, wherein the memory is configured to store instructions that, when executed by the one or more processors, further cause the one or more processors to generate the software test by: upon detecting that each one of the set of properties to be tested is detected, storing a corresponding stressor configuration associated with the detection of each respective one of the set of properties of the software to be detected as part of the software test for testing the software associated with the safety-related system.

In Example 11, the subject matter of any combination of Examples 9-10, wherein modifying the initial stressor configuration includes randomly selecting a stressor configuration having an accompanying set of stress mechanisms that are different than the initial set of stress mechanisms.

In Example 12, the subject matter of any combination of Examples 9-11, wherein determining the property of the software to be tested includes identifying functions of the software associated with the safety-related system to be tested in accordance with a specific state of the safety-related system.

In Example 13, the subject matter of any combination of Examples 9-12, wherein the memory is configured to store instructions that, when executed by the one or more processors, further cause the one or more processors to determine, as the property of the software to be tested whether global variable interference exists between the functions as a result of a variable being used by both a non-safety-related (NSR) function and a safety-related (SR) function.

In Example 14, the subject matter of any combination of Examples 9-13, wherein the memory is configured to store instructions that, when executed by the one or more processors, further cause the one or more processors to determine, as the property of the software to be tested whether static variable interference exists between the functions as a result of a variable that is used by a safety-related (SR) function being called by a non-safety-related (NSR) function.

In Example 15, the subject matter of any combination of Examples 9-14, wherein the stressor is associated with a Linux operating system stressor including at least one of Linux stress-ng and Linux syzkaller.

Example 16 is a software test generation device, comprising: one or more processors; and a memory configured to store instructions that, when executed by the one or more processors, cause the one or more processors to generate a software test for software associated with a safety-related system by: analyzing source code of the software associated with the safety-related system to identify utilized functions and to detect function calls between functions; compiling the source code to generate compiled code including object files and executable files; detecting, based upon an analysis of the compiled code, symbols identified as variables based upon which section of the object files or the executable files the symbols are located; detecting potential global variable interference as a result of a variable from among the detected variables being used by both a non-safety-related (NSR) function and a safety-related (SR) function; and detecting potential static variable interference as a result of a variable from among the detected variables being used by a safety-related (SR) function that is called by a non-safety-related (NSR) function; and generating the software test using the detected instances of potential global variable interference and potential static variable interference.

In Example 17, the subject matter of Example 16, wherein the one or more processors are configured to execute the instructions stored in the memory to detect the symbols identified as variables when the symbols are located in a data section or a block starting symbol (bss) section of the object files or the executable files.

In Example 18, the subject matter of any combination of Examples 16-17, wherein the one or more processors are configured to analyze the source code of the software associated with the safety-related system to identify utilized functions and to detect function calls between functions using a flow graph generator.

In Example 19, the subject matter of any combination of Examples 16-18, wherein the memory is configured to store instructions that, when executed by the one or more processors, further cause the one or more processors to generate the software test by: executing a software stressor in accordance with a stressor configuration that defines software tests to be performed via an initial set of stress mechanisms; capturing a data log of results of executing the software stressor in accordance with each one of the initial set of stress mechanisms; and when the data log indicates that neither the potential static variable interference nor the potential global variable interference is detected: modifying the stressor configuration to define software tests to be performed via a modified set of stress mechanisms that differ from the initial set of stress mechanisms; and repeatedly executing software stressors in accordance with stressor configurations having different respective sets of stress mechanisms and capturing the data log of results of each software stressor execution until it is determined that potential static variable interference or the potential global variable interference is detected.

In Example 20, the subject matter of any combination of Examples 16-19, wherein the software stressor is associated with a Linux operating system stressor including at least one of Linux stress-ng and Linux syzkaller.

Example 21 is a software test means, comprising: processing means; and a storage means for storing instructions that, when executed by the processing means, cause the processing means to generate a software test for software associated with a safety-related system by: determining a property of the software to be tested; executing a software stressor in accordance with a stressor configuration that defines software tests to be performed via an initial set of stress mechanisms; capturing a data log of results of executing the software stressor in accordance with each one of the initial set of stress mechanisms; and when the data log indicates that the property of the software to be tested was not detected: modifying the stressor configuration to define software tests to be performed via a modified set of stress mechanisms that differ from the initial set of stress mechanisms; and repeatedly executing software stressors in accordance with stressor configurations having different respective sets of stress mechanisms and capturing the data log of results of each software stressor execution until the property of the software to be tested is detected.

In Example 22, the subject matter of Example 21, wherein the storage means is configured to store instructions that, when executed by the processing means, further cause the processing means to generate the software test by: upon detecting the property of the software to be tested, storing a corresponding stressor configuration associated with the detection of the property of the software to be detected as part of the software test for testing the software associated with the safety-related system.

In Example 23, the subject matter of any combination of Examples 21-22, wherein the storage means is configured to store instructions that, when executed by the processing means, further cause the processing means to generate the software test by: repeating, for each one of a set of properties of the software to be tested (i) determining a property from among the set of properties of the software to be tested, (ii) executing a software stressor in accordance with respective stressor configurations until each one of a set of properties of the software to be tested is detected, and (iii) storing each corresponding stressor configuration associated with the detection of each respective property of the software to be detected as part of the software test for testing the software associated with the safety-related system.

In Example 24, the subject matter of any combination of Examples 21-23, wherein modifying the initial stressor configuration includes randomly selecting a stressor configuration having an accompanying set of stress mechanisms that are different than the initial set of stress mechanisms.

In Example 25, the subject matter of any combination of Examples 21-24, wherein determining the property of the software to be tested includes identifying functions of the software associated with the safety-related system to be tested in accordance with a specific state of the safety-related system.

In Example 26, the subject matter of any combination of Examples 21-25, wherein the storage means is configured to store instructions that, when executed by the processing means, further cause the processing means to determine, as the property of the software to be tested whether global variable interference exists between the functions as a result of a variable being used by both a non-safety-related (NSR) function and a safety-related (SR) function.

In Example 27, the subject matter of any combination of Examples 21-26, wherein the storage means is configured to store instructions that, when executed by the processing means, further cause the processing means to determine, as the property of the software to be tested whether static variable interference exists between the functions as a result of a variable that is used by a safety-related (SR) function being called by a non-safety-related (NSR) function.

In Example 28, the subject matter of any combination of Examples 21-27, wherein the stressor is associated with a Linux operating system stressor including at least one of Linux stress-ng and Linux syzkaller.

Example 29 is a software test means, comprising: a processing means; and a storage means configured to store instructions that, when executed by the processing means, cause the processing means to generate a software test for software associated with a safety-related system by: determining a set of properties of the software to be tested; executing a software stressor in accordance with a stressor configuration that defines software tests to be performed via an initial set of stress mechanisms; capturing a data log of results of executing the software stressor in accordance with each one of the initial set of stress mechanisms; and when the data log indicates that none of the set of properties of the software to be tested was detected: modifying the stressor configuration to define software tests to be performed via a modified set of stress mechanisms that differ from the initial set of stress mechanisms; and repeatedly executing software stressors in accordance with stressor configurations having different respective sets of stress mechanisms and capturing the data log of results of each software stressor execution until each one of the set of properties to be tested is detected.

In Example 30, the subject matter of Example 29, wherein the storage means is configured to store instructions that, when executed by the processing means, further cause the processing means to generate the software test by: upon detecting that each one of the set of properties to be tested is detected, storing a corresponding stressor configuration associated with the detection of each respective one of the set of properties of the software to be detected as part of the software test for testing the software associated with the safety-related system.

In Example 31, the subject matter of any combination of Examples 29-30, wherein modifying the initial stressor configuration includes randomly selecting a stressor configuration having an accompanying set of stress mechanisms that are different than the initial set of stress mechanisms.

In Example 32, the subject matter of any combination of Examples 29-31, wherein determining the property of the software to be tested includes identifying functions of the software associated with the safety-related system to be tested in accordance with a specific state of the safety-related system.

In Example 33, the subject matter of any combination of Examples 29-32, wherein the storage means is configured to store instructions that, when executed by the processing means, further cause the processing means to determine, as the property of the software to be tested whether global variable interference exists between the functions as a result of a variable being used by both a non-safety-related (NSR) function and a safety-related (SR) function.

In Example 34, the subject matter of any combination of Examples 39-33, wherein the storage means is configured to store instructions that, when executed by the processing means, further cause the processing means to determine, as the property of the software to be tested whether static variable interference exists between the functions as a result of a variable that is used by a safety-related (SR) function being called by a non-safety-related (NSR) function.

In Example 35, the subject matter of any combination of Examples 29-34, wherein the stressor is associated with a Linux operating system stressor including at least one of Linux stress-ng and Linux syzkaller.

Example 36 is a software test means, comprising: processing means; and a storage means configured to store instructions that, when executed by the processing means, cause the processing means to generate a software test for software associated with a safety-related system by: analyzing source code of the software associated with the safety-related system to identify utilized functions and to detect function calls between functions; compiling the source code to generate compiled code including object files and executable files; detecting, based upon an analysis of the compiled code, symbols identified as variables based upon which section of the object files or the executable files the symbols are located; detecting potential global variable interference as a result of a variable from among the detected variables being used by both a non-safety-related (NSR) function and a safety-related (SR) function; and detecting potential static variable interference as a result of a variable from among the detected variables being used by a safety-related (SR) function that is called by a non-safety-related (NSR) function; and generating the software test using the detected instances of potential global variable interference and potential static variable interference.

In Example 37, the subject matter of Example 36, wherein the processing means are configured to execute the instructions stored in the memory to detect the symbols identified as variables when the symbols are located in a data section or a block starting symbol (bss) section of the object files or the executable files.

In Example 38, the subject matter of any combination of Examples 36-37, wherein the processing means are configured to analyze the source code of the software associated with the safety-related system to identify utilized functions and to detect function calls between functions using a flow graph generator.

In Example 39, the subject matter of any combination of Examples 36-38, wherein the storage means is configured to store instructions that, when executed by the processing means, further cause the processing means to generate the software test by: executing a software stressor in accordance with a stressor configuration that defines software tests to be performed via an initial set of stress mechanisms; capturing a data log of results of executing the software stressor in accordance with each one of the initial set of stress mechanisms; and when the data log indicates that neither the potential static variable interference nor the potential global variable interference is detected: modifying the stressor configuration to define software tests to be performed via a modified set of stress mechanisms that differ from the initial set of stress mechanisms; and repeatedly executing software stressors in accordance with stressor configurations having different respective sets of stress mechanisms and capturing the data log of results of each software stressor execution until it is determined that potential static variable interference or the potential global variable interference is detected.

In Example 40, the subject matter of any combination of Examples 36-39, wherein the software stressor is associated with a Linux operating system stressor including at least one of Linux stress-ng and Linux syzkaller.

An apparatus as shown and described.

A method as shown and described.

### CONCLUSION

The aforementioned description of the specific aspects will so fully reveal the general nature of the disclosure that others can, by applying knowledge within the skill of the art, readily modify and/or adapt for various applications such specific aspects, without undue experimentation, and without departing from the general concept of the present disclosure. Therefore, such adaptations and modifications are intended to be within the meaning and range of equivalents of the disclosed aspects, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

References in the specification to “one aspect,” “an aspect,” “an exemplary aspect,” etc., indicate that the aspect described may include a particular feature, structure, or characteristic, but every aspect may not necessarily include the particular feature, structure, or characteristic. Moreover, such phrases are not necessarily referring to the same aspect. Further, when a particular feature, structure, or characteristic is described in connection with an aspect, it is submitted that it is within the knowledge of one skilled in the art to affect such feature, structure, or characteristic in connection with other aspects whether or not explicitly described.

The exemplary aspects described herein are provided for illustrative purposes, and are not limiting. Other exemplary aspects are possible, and modifications may be made to the exemplary aspects. Therefore, the specification is not meant to limit the disclosure. Rather, the scope of the disclosure is defined only in accordance with the following claims and their equivalents.

Aspects may be implemented in hardware (e.g., circuits), firmware, software, or any combination thereof. Aspects may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RANI); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact results from computing devices, processors, controllers, or other devices executing the firmware, software, routines, instructions, etc. Further, any of the implementation variations may be carried out by a general purpose computer.

The word “exemplary” is used herein to mean “serving as an example, instance, or illustration”. Any embodiment or design described herein as “exemplary” is not necessarily to be construed as preferred or advantageous over other embodiments or designs.

Throughout the drawings, it should be noted that like reference numbers are used to depict the same or similar elements, features, and structures, unless otherwise noted.

The terms “at least one” and “one or more” may be understood to include a numerical quantity greater than or equal to one (e.g., one, two, three, four, [ . . . ], etc.). The term “a plurality” may be understood to include a numerical quantity greater than or equal to two (e.g., two, three, four, five, [ . . . ], etc.).

The words “plural” and “multiple” in the description and in the claims expressly refer to a quantity greater than one. Accordingly, any phrases explicitly invoking the aforementioned words (e.g., “plural [elements]”, “multiple [elements]”) referring to a quantity of elements expressly refers to more than one of the said elements. The terms “group (of)”, “set (of)”, “collection (of)”, “series (of)”, “sequence (of)”, “grouping (of)”, etc., and the like in the description and in the claims, if any, refer to a quantity equal to or greater than one, i.e., one or more. The terms “proper subset”, “reduced subset”, and “lesser subset” refer to a subset of a set that is not equal to the set, illustratively, referring to a subset of a set that contains less elements than the set.

The phrase “at least one of” with regard to a group of elements may be used herein to mean at least one element from the group consisting of the elements. For example, the phrase “at least one of” with regard to a group of elements may be used herein to mean a selection of: one of the listed elements, a plurality of one of the listed elements, a plurality of individual listed elements, or a plurality of a multiple of individual listed elements.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term “data”, however, is not limited to the aforementioned examples and may take various forms and represent any information as understood in the art.

The terms “processor” or “controller” as, for example, used herein may be understood as any kind of technological entity that allows handling of data. The data may be handled according to one or more specific functions executed by the processor or controller. Further, a processor or controller as used herein may be understood as any kind of circuit, e.g., any kind of analog or digital circuit. A processor or a controller may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. Any other kind of implementation of the respective functions, which will be described below in further detail, may also be understood as a processor, controller, or logic circuit. It is understood that any two (or more) of the processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

As used herein, “memory” is understood as a computer-readable medium in which data or information can be stored for retrieval. References to “memory” included herein may thus be understood as referring to volatile or non-volatile memory, including random access memory (RAM), read-only memory (ROM), flash memory, solid-state storage, magnetic tape, hard disk drive, optical drive, among others, or any combination thereof. Registers, shift registers, processor registers, data buffers, among others, are also embraced herein by the term memory. The term “software” refers to any type of executable instruction, including firmware.

In one or more of the exemplary aspects described herein, processing circuitry can include memory that stores data and/or instructions. The memory can be any well-known volatile and/or non-volatile memory, including, for example, read-only memory (ROM), random access memory (RAM), flash memory, a magnetic storage media, an optical disc, erasable programmable read only memory (EPROM), and programmable read only memory (PROM). The memory can be non-removable, removable, or a combination of both.

Unless explicitly specified, the term “transmit” encompasses both direct (point-to-point) and indirect transmission (via one or more intermediary points). Similarly, the term “receive” encompasses both direct and indirect reception. Furthermore, the terms “transmit,” “receive,” “communicate,” and other similar terms encompass both physical transmission (e.g., the transmission of radio signals) and logical transmission (e.g., the transmission of digital data over a logical software-level connection). For example, a processor or controller may transmit or receive data over a software-level connection with another processor or controller in the form of radio signals, where the physical transmission and reception is handled by radio-layer components such as RF transceivers and antennas, and the logical transmission and reception over the software-level connection is performed by the processors or controllers. The term “communicate” encompasses one or both of transmitting and receiving, i.e., unidirectional or bidirectional communication in one or both of the incoming and outgoing directions. The term “calculate” encompasses both ‘direct’ calculations via a mathematical expression/formula/relationship and ‘indirect’ calculations via lookup or hash tables and other array indexing or searching operations.

A “vehicle” may be understood to include any type of driven object. By way of example, a vehicle may be a driven object with a combustion engine, a reaction engine, an electrically driven object, a hybrid driven object, or a combination thereof. A vehicle may be or may include an automobile, a bus, a mini bus, a van, a truck, a mobile home, a vehicle trailer, a motorcycle, a bicycle, a tricycle, a train locomotive, a train wagon, a moving robot, a personal transporter, a boat, a ship, a submersible, a submarine, a drone, an aircraft, a rocket, and the like.

A “ground vehicle” may be understood to include any type of vehicle, as described above, which is driven on the ground, e.g., on a street, on a road, on a track, on one or more rails, off-road, etc.

The term “autonomous vehicle” may describe a vehicle that implements all or substantially all navigational changes, at least during some (significant) part (spatial or temporal, e.g., in certain areas, or when ambient conditions are fair, or on highways, or above or below a certain speed) of some drives. Sometimes an “autonomous vehicle” is distinguished from a “partially autonomous vehicle” or a “semi-autonomous vehicle” to indicate that the vehicle is capable of implementing some (but not all) navigational changes, possibly at certain times, under certain conditions, or in certain areas. A navigational change may describe or include a change in one or more of steering, braking, or acceleration/deceleration of the vehicle. A vehicle may be described as autonomous even in case the vehicle is not fully automatic (for example, fully operational with driver or without driver input). Autonomous vehicles may include those vehicles that can operate under driver control during certain time periods and without driver control during other time periods. Autonomous vehicles may also include vehicles that control only some aspects of vehicle navigation, such as steering (e.g., to maintain a vehicle course between vehicle lane constraints) or some steering operations under certain circumstances (but not under all circumstances), but may leave other aspects of vehicle navigation to the driver (e.g., braking or braking under certain circumstances). Autonomous vehicles may also include vehicles that share the control of one or more aspects of vehicle navigation under certain circumstances (e.g., hands-on, such as responsive to a driver input) and vehicles that control one or more aspects of vehicle navigation under certain circumstances (e.g., hands-off, such as independent of driver input). Autonomous vehicles may also include vehicles that control one or more aspects of vehicle navigation under certain circumstances, such as under certain environmental conditions (e.g., spatial areas, roadway conditions). In some aspects, autonomous vehicles may handle some or all aspects of braking, speed control, velocity control, and/or steering of the vehicle. An autonomous vehicle may include those vehicles that can operate without a driver. The level of autonomy of a vehicle may be described or determined by the Society of Automotive Engineers (SAE) level of the vehicle (e.g., as defined by the SAE, for example in SAE J3016 2018: Taxonomy and definitions for terms related to driving automation systems for on road motor vehicles) or by other relevant professional organizations. The SAE level may have a value ranging from a minimum level, e.g. level 0 (illustratively, substantially no driving automation), to a maximum level, e.g. level 5 (illustratively, full driving automation).

What is claimed is:

1. A software test generation device, comprising:
one or more processors; and
a memory configured to store instructions that, when executed by the one or more processors, cause the one or more processors to generate a software test for software associated with a safety-related system by:
determining a property of the software to be tested;
executing a software stressor in accordance with a stressor configuration that defines software tests to be performed via an initial set of stress mechanisms;
capturing a data log of results of executing the software stressor in accordance with each one of the initial set of stress mechanisms; and
when the data log indicates that the property of the software to be tested was not detected:
modifying the stressor configuration to define software tests to be performed via a modified set of stress mechanisms that differ from the initial set of stress mechanisms; and
repeatedly executing software stressors in accordance with stressor configurations having different respective sets of stress mechanisms and capturing the data log of results of each software stressor execution until the property of the software to be tested is detected.

2. The software test generation device of claim 1, wherein the memory is configured to store instructions that, when executed by the one or more processors, further cause the one or more processors to generate the software test by:
upon detecting the property of the software to be tested, storing a corresponding stressor configuration associated with the detection of the property of the software to be detected as part of the software test for testing the software associated with the safety-related system.

3. The software test generation device of claim 1, wherein the memory is configured to store instructions that, when executed by the one or more processors, further cause the one or more processors to generate the software test by:
repeating, for each one of a set of properties of the software to be tested (i) determining a property from among the set of properties of the software to be tested, (ii) executing a software stressor in accordance with respective stressor configurations until each one of a set of properties of the software to be tested is detected, and (iii) storing each corresponding stressor configuration associated with the detection of each respective property of the software to be detected as part of the software test for testing the software associated with the safety-related system.

4. The software test generation device of claim 1, wherein modifying the initial stressor configuration includes randomly selecting a stressor configuration having an accompanying set of stress mechanisms that are different than the initial set of stress mechanisms.

5. The software test generation device of claim 1, wherein determining the property of the software to be tested includes identifying functions of the software associated with the safety-related system to be tested in accordance with a specific state of the safety-related system.

6. The software test generation device of claim 5, wherein the memory is configured to store instructions that, when executed by the one or more processors, further cause the one or more processors to determine, as the property of the software to be tested whether global variable interference exists between the functions as a result of a variable being used by both a non-safety-related (NSR) function and a safety-related (SR) function.

7. The software test generation device of claim 5, wherein the memory is configured to store instructions that, when executed by the one or more processors, further cause the one or more processors to determine, as the property of the software to be tested whether static variable interference exists between the functions as a result of a variable that is used by a safety-related (SR) function being called by a non-safety-related (NSR) function.

8. The software test generation device of claim 5, wherein the stressor is associated with a Linux operating system stressor including at least one of Linux stress-ng and Linux syzkaller.

9. A software test generation device, comprising:
one or more processors; and
a memory configured to store instructions that, when executed by the one or more processors, cause the one or more processors to generate a software test for software associated with a safety-related system by:
determining a set of properties of the software to be tested;
executing a software stressor in accordance with a stressor configuration that defines software tests to be performed via an initial set of stress mechanisms;
capturing a data log of results of executing the software stressor in accordance with each one of the initial set of stress mechanisms; and
when the data log indicates that none of the set of properties of the software to be tested was detected:
modifying the stressor configuration to define software tests to be performed via a modified set of stress mechanisms that differ from the initial set of stress mechanisms; and
repeatedly executing software stressors in accordance with stressor configurations having different respective sets of stress mechanisms and capturing the data log of results of each software stressor execution until each one of the set of properties to be tested is detected.

10. The software test generation device of claim 9, wherein the memory is configured to store instructions that, when executed by the one or more processors, further cause the one or more processors to generate the software test by:
upon detecting that each one of the set of properties to be tested is detected, storing a corresponding stressor configuration associated with the detection of each respective one of the set of properties of the software to be detected as part of the software test for testing the software associated with the safety-related system.

11. The software test generation device of claim 9, wherein modifying the initial stressor configuration includes randomly selecting a stressor configuration having an accompanying set of stress mechanisms that are different than the initial set of stress mechanisms.

12. The software test generation device of claim 9, wherein determining the property of the software to be tested includes identifying functions of the software associated with the safety-related system to be tested in accordance with a specific state of the safety-related system.

13. The software test generation device of claim 12, wherein the memory is configured to store instructions that, when executed by the one or more processors, further cause the one or more processors to determine, as the property of the software to be tested whether global variable interference exists between the functions as a result of a variable being used by both a non-safety-related (NSR) function and a safety-related (SR) function.

14. The software test generation device of claim 12, wherein the memory is configured to store instructions that, when executed by the one or more processors, further cause the one or more processors to determine, as the property of the software to be tested whether static variable interference exists between the functions as a result of a variable that is used by a safety-related (SR) function being called by a non-safety-related (NSR) function.

15. The software test generation device of claim 9, wherein the stressor is associated with a Linux operating system stressor including at least one of Linux stress-ng and Linux syzkaller.

16. A software test generation device, comprising:
one or more processors; and
a memory configured to store instructions that, when executed by the one or more processors, cause the one or more processors to generate a software test for software associated with a safety-related system by:
analyzing source code of the software associated with the safety-related system to identify utilized functions and to detect function calls between functions;
compiling the source code to generate compiled code including object files and executable files;
detecting, based upon an analysis of the compiled code, symbols identified as variables based upon which section of the object files or the executable files the symbols are located;
detecting potential global variable interference as a result of a variable from among the detected variables being used by both a non-safety-related (NSR) function and a safety-related (SR) function; and
detecting potential static variable interference as a result of a variable from among the detected variables being used by a safety-related (SR) function that is called by a non-safety-related (NSR) function; and
generating the software test using the detected instances of potential global variable interference and potential static variable interference.

17. The software test generation device of claim 16, wherein the one or more processors are configured to execute the instructions stored in the memory to detect the symbols identified as variables when the symbols are located in a data section or a block starting symbol (bss) section of the object files or the executable files.

18. The software test generation device of claim 16, wherein the one or more processors are configured to analyze the source code of the software associated with the safety-related system to identify utilized functions and to detect function calls between functions using a flow graph generator.

19. The software test generation device of claim 14, wherein the memory is configured to store instructions that, when executed by the one or more processors, further cause the one or more processors to generate the software test by:
executing a software stressor in accordance with a stressor configuration that defines software tests to be performed via an initial set of stress mechanisms;
capturing a data log of results of executing the software stressor in accordance with each one of the initial set of stress mechanisms; and
when the data log indicates that neither the potential static variable interference nor the potential global variable interference is detected:
modifying the stressor configuration to define software tests to be performed via a modified set of stress mechanisms that differ from the initial set of stress mechanisms; and
repeatedly executing software stressors in accordance with stressor configurations having different respective sets of stress mechanisms and capturing the data log of results of each software stressor execution until it is determined that potential static variable interference or the potential global variable interference is detected.

20. The software test generation device of claim 19, wherein the software stressor is associated with a Linux operating system stressor including at least one of Linux stress-ng and Linux syzkaller.
